(19) United States
(12) Patent Application Publication
(10) Pub. No.: US 2026/0285332 A1
(43) Pub. Date: Sep. 24, 2026

(54) SYSTEMS AND METHODS FOR ONLINE CALIBRATION OF VEHICLE SENSORS USING MAGNETIC SENSORS

(71) Applicant: Torc Robotics, Inc., Blacksburg, VA (US)

(72) Inventors: Maximilian Yassine Beyen, Leutenbach (DE); Marat Kopytjuk, Heilbronn (DE); Maximilian Koeper, Ostfidern (DE); Simon Baeuerle, Kassel (DE); Margarita Kunjavskaja, Gerlingen (DE)

(21) Appl. No.: 19/086,981

(22) Filed: Mar. 21, 2025

(51) Int. Cl. B60W 50/02; B60W 50/00

(52) U.S. Cl. CPC B60W 50/0205; B60W 2050/0075; B60W 2420/50; B60W 2520/14

(57) ABSTRACT

A system for online sensor calibration can include one or more magnetic sensors mounted to a vehicle and a processing device in communication with the one or more magnetic sensors. The processing device can be configured to execute instructions stored in a memory to perform operations comprising receiving, from the one or more magnetic sensors, measurements indicative of one or more induced voltages of the one or more magnetic sensors responsive to the vehicle driving by a magnetic element, determining, using the measurements received from the one or more magnetic sensors, one or more kinematic parameters of the vehicle, and calibrating, using the one or more kinematic parameters of the vehicle, one or more sensors of the vehicle.

### TECHNICAL FIELD

The field of the disclosure relates to calibration of vehicle sensors and, in particular, to using magnetic sensors for online calibration of vehicle sensors.

### BACKGROUND

Modern vehicles, and in particular autonomous and semi-autonomous vehicles, include a variety of sensors to perceive their surroundings. The sensors are critical components especially for autonomous and semi-autonomous vehicles, because they act as the “eyes” and “ears” of the corresponding vehicles. In particular, the sensors provide via respective sensing techniques various perceptions of the surroundings or environment of the vehicle to enable various driver-assistance features and/or self-driving features. Sensors installed in a modern vehicle constantly monitor a multitude of parameters of the vehicle and its surrounding. Such parameters can include, e.g., engine temperature, oil pressure, tire pressure, vehicle speed, as well as the speed, distance, and relative position of objects around the vehicle. Sensor data collected by the vehicle sensors is typically fed or provided to one or more processing devices or units, such as the electronic control unit (ECU), which can be used to make real-time adjustments or decisions related to various systems of the vehicle.

With advancements in sensing technology and artificial intelligence, modern vehicles are equipped with a wide array of sensors to enable advanced driver-assistance systems (ADASs) and/or automated driving systems (ADSs). These systems rely mainly on sensor data provided by the sensors onboard the vehicle in decision making. As technology continues to evolve and vehicles become more automated, the role of sensors in modern vehicles becomes greater and more critical. In other words, the operation of modern vehicles, and automated vehicles in particular, depends on the reliability and accuracy of the sensors. For example, failure to accurately perceive the surroundings of an autonomous vehicle or failure to point the vehicle in the right direction could result in catastrophic accidents. Also, failure to detect defective or malfunctioning components in the vehicle can be costly.

Reliability and accuracy of onboard sensors calls for proper configuration and repeated calibration of the sensors. Sensor configuration involves setting the proper parameters of the sensors during the production phase or when replacing a sensor on the vehicle. Sensor calibration involves adjusting the sensors during the deployment phase of the vehicle to correct for any deviations in the sensor measurements. Deviations or offsets in sensor measurements can occur over time due to general sensor use or exposure of the sensor to various vehicle operating environments and associated operating factors, e.g. vibratory disturbances. Vehicles are able to be operated most efficiently and effectively when the sensors are accurately configured and calibrated. Therefore, there is a need to ensure that sensors are effectively and reliably calibrated and configured during the production and deployment phases of vehicle operation.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an example system for online sensor calibration in vehicles is provided. The system can include one or more magnetic sensors mounted to a vehicle and a processing device in communication with the one or more magnetic sensors. The processing device can be configured to execute instructions stored in a memory to perform operations comprising receiving, from the one or more magnetic sensors, measurements indicative of one or more induced voltages of the one or more magnetic sensors responsive to the vehicle driving by a magnetic element, determining, using the measurements received from the one or more magnetic sensors, one or more kinematic parameters of the vehicle, and calibrating, using the one or more kinematic parameters of the vehicle, one or more sensors of the vehicle.

In some implementations, the magnetic element can include a magnetic strip placed on a road surface.

In some implementations, the one or more kinematic parameters of the vehicle can include at least one of a velocity of the vehicle or a yaw rate of the vehicle.

In some implementations, the processing device can be configured to determine, using the measurements received from the one or more magnetic sensors, a dynamic rolling radius of the vehicle.

In some implementations, the one or more magnetic sensors can be mounted at an underside of the vehicle.

In some implementations, the one or more magnetic sensors can include at least one of one or more magnetic sensor aligned along a length dimension of the vehicle or a pair of magnetic sensors aligned along a width dimension of the vehicle and spaced apart by a distance along the length dimension of the vehicle.

In some implementations, the processing device can be configured to determine a time shift between first measurements from a first magnetic sensor aligned along a width dimension of the vehicle and second measurements from a second magnetic sensor aligned along the width dimension of the vehicle. The first and second magnetic sensors can be spaced apart by a distance along a length dimension of the vehicle. The processing device can determine a speed of the vehicle by dividing the distance between the first and second magnetic sensors spaced along the length dimension of the vehicle by the time shift between the first and second measurements.

In some implementations, the processing device can be configured to determine a duration of measurements received from one or more magnetic sensors aligned along a length dimension of the vehicle, and determine a speed of the vehicle by dividing a distance defined by at least one of (i) a dimension of the one or more magnetic sensors aligned along the length dimension of the vehicle or (ii) a dimension of the magnetic element.

In some implementations, the processing device can be configured to compare a first profile of measurements received from a first magnetic sensor and a second profile of measurements received from a second magnetic sensor, the first and second sensors aligned along a length dimension of the vehicle, and determine a yaw rate of the vehicle based on the comparison between the first profile and the second profile.

In some implementations, the processing device can be configured to compare a profile of measurements received from a magnetic sensor aligned along a length dimension of the vehicle and a reference profile, and determine a yaw rate of the vehicle based on the comparison between the reference profile and the profile of the measurements received from the magnetic sensor aligned along the length dimension of the vehicle.

In some implementations, to determine the one or more kinematic parameters of the vehicle, the processing device can be configured to provide the measurement received from the rom the one or more magnetic sensors as input to trained machine learning model, and execute the trained machine learning model to obtain output from the trained machine learning model indicative of the one or more kinematic parameters of the vehicle.

In some implementations, the processing device can be configured to calibrate, using the one or more kinematic parameters of the vehicle, at least one of an inertial measurement unit (IMU) of the vehicle, a velocity measured by radar sensor of the vehicle, or a velocity measured by global positioning system (GPS) device of the vehicle.

In another aspect, an example method for online sensor calibration in vehicles is provided. The method can include receiving, by a processing device, from one or more magnetic sensors mounted to a vehicle, measurements indicative of one or more induced voltages of the one or more magnetic sensors responsive to the vehicle driving by a magnetic element, determining, by the processing device, using the measurements received from the one or more magnetic sensors, one or more kinematic parameters of the vehicle, and calibrating, using the one or more kinematic parameters of the vehicle, one or more sensors of the vehicle.

In some implementations, the magnetic element can include a magnetic strip placed on a road surface.

In some implementations, the one or more kinematic parameters of the vehicle can include at least one of a velocity of the vehicle or a yaw rate of the vehicle.

In some implementations, the method can include determining, using the measurements received from the one or more magnetic sensors, a dynamic rolling radius of the vehicle.

In some implementations, the one or more magnetic sensors can be mounted at an underside of the vehicle.

In some implementations, the one or more magnetic sensors can include at least one of one or more magnetic sensor aligned along a length dimension of the vehicle or a pair of magnetic sensors aligned along a width dimension of the vehicle and spaced apart by a distance along the length dimension of the vehicle.

In some implementations, the method can include determining a time shift between first measurements from a first magnetic sensor aligned along a width dimension of the vehicle and second measurements from a second magnetic sensor aligned along the width dimension of the vehicle. The first and second magnetic sensors can be spaced apart by a distance along a length dimension of the vehicle. The method can include determining a speed of the vehicle by dividing the distance between the first and second magnetic sensors spaced along the length dimension of the vehicle by the time shift between the first and second measurements.

In some implementations, the method can include determining a duration of measurements received from one or more magnetic sensors aligned along a length dimension of the vehicle, and determining a speed of the vehicle by dividing a distance defined by at least one of (i) a dimension of the one or more magnetic sensors aligned along the length dimension of the vehicle or (ii) a dimension of the magnetic element.

In some implementations, the method can include comparing a first profile of measurements received from a first magnetic sensor and a second profile of measurements received from a second magnetic sensor. The first and second sensors can be aligned along a length dimension of the vehicle. The method can include determining a yaw rate of the vehicle based on the comparison between the first profile and the second profile.

In some implementations, the method can include comparing a profile of measurements received from a magnetic sensor aligned along a length dimension of the vehicle and a reference profile, and determining a yaw rate of the vehicle based on the comparison between the reference profile and the profile of the measurements received from the magnetic sensor aligned along the length dimension of the vehicle.

In some implementations, determining the one or more kinematic parameters of the vehicle can include providing the measurement received from the one or more magnetic sensors as input to trained machine learning model, and executing the trained machine learning model to obtain output from the trained machine learning model indicative of the one or more kinematic parameters of the vehicle.

In some implementations, the method can include calibrating, using the one or more kinematic parameters of the vehicle, at least one of an inertial measurement unit (IMU) of the vehicle, a velocity measured by radar sensor of the vehicle, or a velocity measured by global positioning system (GPS) device of the vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a diagram of an environment for online calibration of vehicle sensors, according to example embodiment of the current disclosure.

FIG. 7 is a flowchart of a method for online calibration of vehicle sensors, according to an example embodiment of the current disclosure.

FIG. 8 depicts a diagram of a configuration of magnetic sensors mounted to a vehicle and corresponding voltage measurements, according to an example embodiment of the current disclosure.

FIG. 9 depicts a diagram of another configuration of magnetic sensors mounted to the vehicle and corresponding voltage measurements, according to an example embodiment of the current disclosure.

FIG. 10 depicts a diagram of yet another configuration of magnetic sensors mounted to the vehicle and corresponding voltage measurements, according to an example embodiment of the current disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As modern vehicles become more automated, the reliability and accuracy of vehicle sensors become increasingly important. In particular, the automated driving system (ADS) in an autonomous vehicle relies on the vehicle sensors to perceive or understand the surrounding or environment of the vehicle, and make proper decisions to automatically operate the vehicle. However, vehicle sensors become out of calibration overtime due to various factors, such as daily normal use, changes in temperature, vibrations, vehicle part replacements and/or accidents. The miscalibration of the sensors implies inaccuracies of measurements or data provided by the sensors. Inaccurate and/or unreliable sensor data, especially in autonomous or semi-autonomous vehicles, leads to serious safety issues or risks. For example, inaccurate sensing of kinematic parameters, such as linear and/or angular velocities, of the vehicle can lead to violations of traffic rules and/or dangerous situations. Inaccurate sensing of the kinematic parameters of the vehicle can lead to unintended driving across lane lines, inaccurate positioning of the vehicle relative to other vehicles or objects, unintended speeding, and/or collisions. Also, having different vehicle sensors providing non-consistent measurements of the kinematic parameters can lead to confusion when applying sensor fusion.

The unavoidable and frequent miscalibration of vehicle sensors as well as the safety issues or risks associated with sensor miscalibration in autonomous or semi-autonomous vehicles has created the critical need for repeated and reliable calibrations or recalibrations of vehicle sensors to ensure reliability and accuracy of the corresponding sensor data. However, the sensor calibration process can be time consuming and disruptive to normal use or normal operations of the vehicle. For example, some of the sensors of ego trucks and/or other ego vehicles are required to be calibrated after each trip or after a defined traveled distance, and as a result, the associated vehicle is taken off road while the sensors are undergoing calibration or recalibration.

Kinematic parameters of an ego vehicle can be measured by various vehicle sensors, such as vehicle speed sensor (VSS), inertial measurement unit (IMU), radio detection and ranging (radar) sensor(s) and/or light detection and ranging (LiDAR) sensor(s) among other types of sensors. Also, a global navigation satellite system (GNSS) receiver can provide measurements or estimates of the kinematic parameters of the vehicle. The vehicle sensors and the GNSS receiver can be affected in indifferent ways by factors such as normal use, temperature, vibrations, maintenance, part replacement and/or accidents. These factors can cause one or more of the vehicle sensors and/or the GNSS receiver to become out of calibration, possibly in different ways. For example, measurements of the linear velocity of the vehicle generated by the vehicle sensors and/or the GNSS receiver can drift by different offset values.

The above discussed factors leading to sensor miscalibration are of a dynamic nature. For example, the vibration and/or temperature experienced by the vehicle depend on the roads and areas through which the vehicle traveled. As such, any of the sensors used to measure vehicle kinematic parameters can become out of calibration at any time, e.g., even after a recent calibration. Also, sensor calibration is typically time consuming and disruptive to vehicle operation since vehicles are typically calibrated in designated and controlled sites. Therefore, there is a need for online sensor calibration. As used herein, online sensor calibration refers to calibration of vehicle sensors while the vehicle is traveling or in driving mode.

Embodiments described herein enable systems and methods for online sensor calibration using magnetic sensors mounted to the vehicle. A magnetic element can be placed or installed on the surface of a road. As the vehicle drives by the magnetic element, the magnetic sensors of the vehicle will sense the magnetic field of the magnetic element and can generate measurements indicative of the magnetic field. The measurements depend on the relative position of each magnetic sensor with respect to the magnetic element on the surface of the road, and can be used to determine kinematic parameters of the vehicle.

While embodiment described herein describe a single magnetic element placed or installed on the surface of a road, a person skilled in the art would appreciate that one or more magnetic elements can be used on the road surface, on the side of the road and/or above the road.

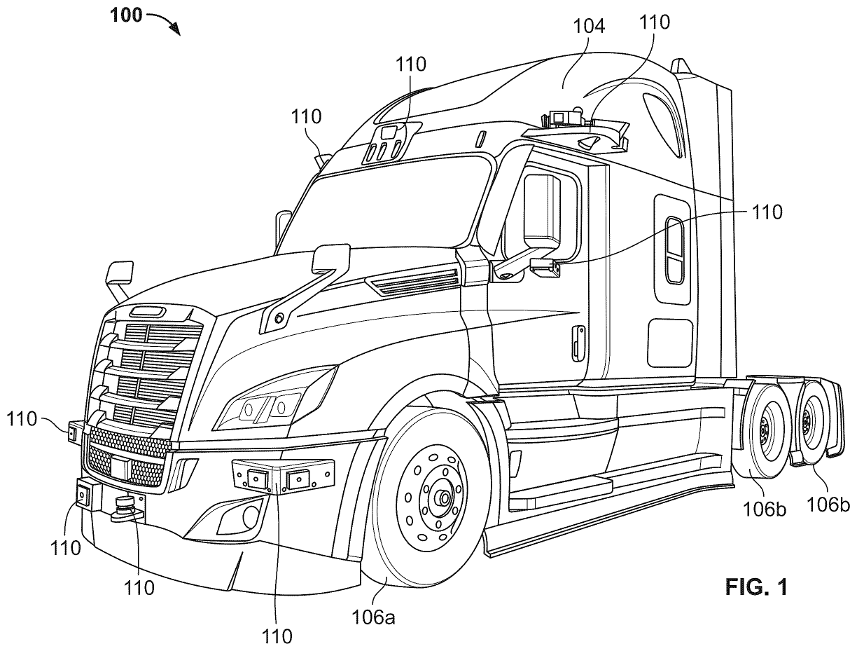

Various embodiments in the present disclosure are described with reference to FIGS. 1-10 below.

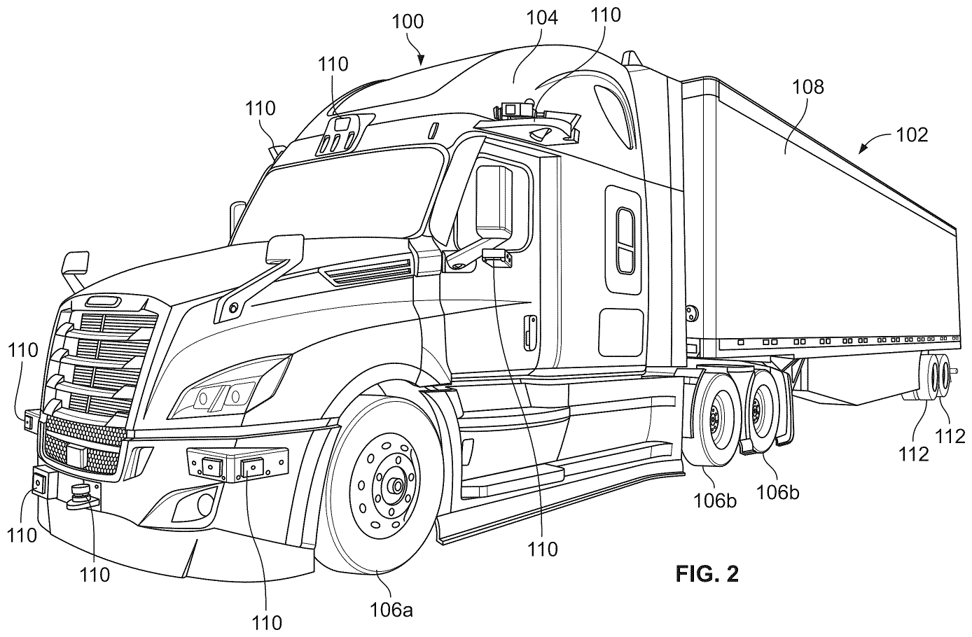

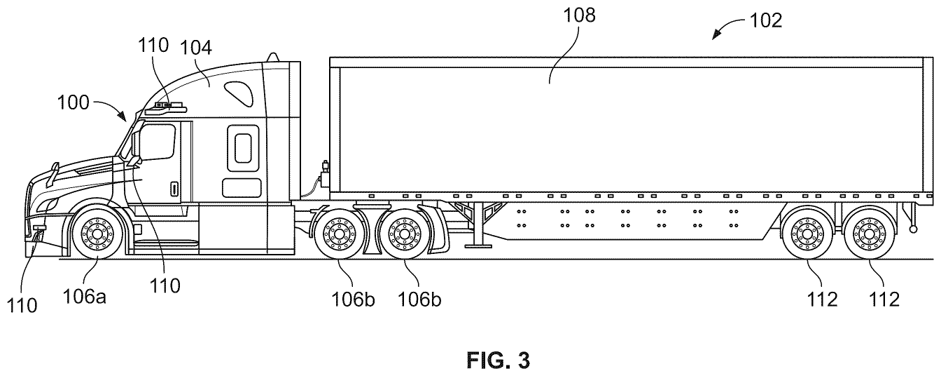

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

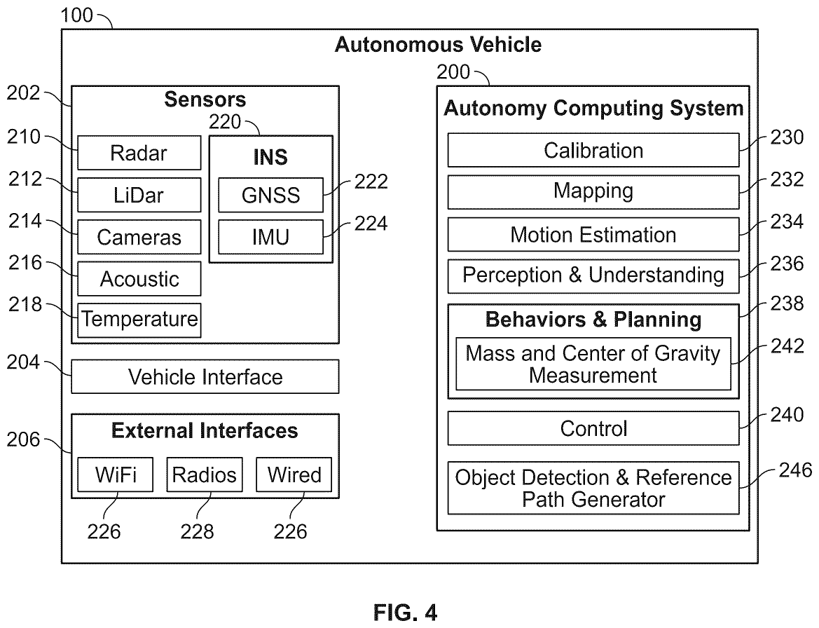

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

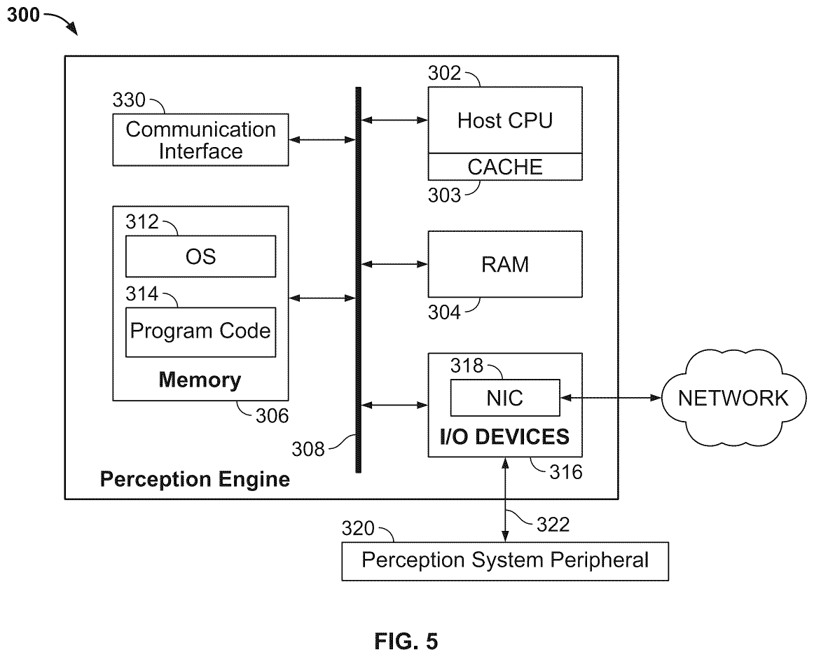

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

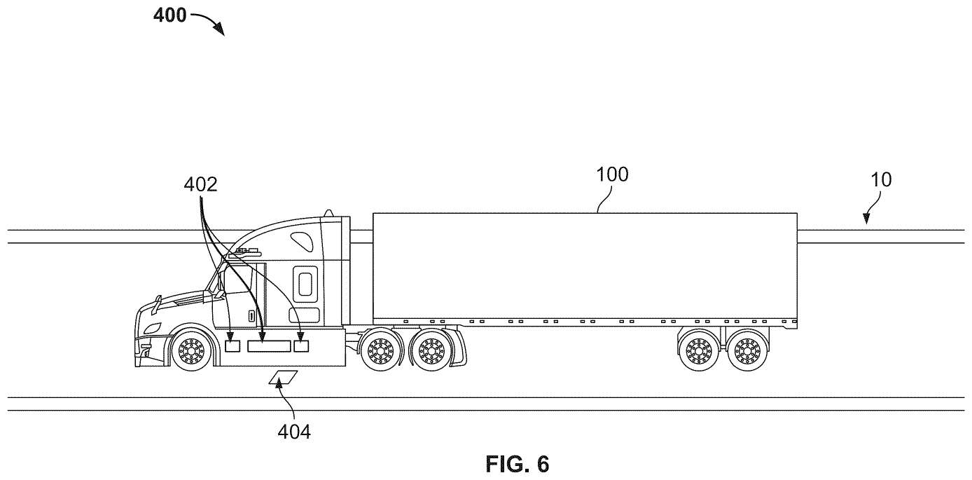

Referring now to FIG. 6, a diagram of an environment 400 for online calibration of vehicle sensors is shown, according to example embodiment of the current disclosure. As used herein, online calibration refers to sensor calibration while the vehicle 100 is on the road. The environment 400 can include a vehicle 100 having one or more magnetic sensors 402 and traveling or driving on a road 10 having a magnetic element 404. The magnetic element 404 can include a magnetic strip placed on the surface of the road 10. The magnetic element 404 or the magnetic strip can generate a magnetic field that is detected by the one or more magnetic sensors 402. The one or more magnetic sensors 402 can be mounted at an underside of the vehicle 100. The magnetic sensor(s) 402 can be referred to herein as induction (or inductive) sensor(s).

Each of the one or more magnetic sensors 402 can be or can include a sensor that converts the magnitude and variations of a magnetic field into electric signals. As the vehicle 100 travels or drives by the magnetic element 404, each of the one or more magnetic sensors 402 detects or senses the magnetic field generated by the magnetic element 404. Specifically, each magnetic sensor 402 can detect or sense the varying magnitude of the magnetic field generated by the magnetic element 404 along the path traveled by the magnetic sensor 402. The sensed magnitude of the magnetic field depends on the varying position and/or orientation of the magnetic sensor 402 relative to the magnetic element 404 as the vehicle 100 drives or travels by the magnetic element 404. For each magnetic sensor 402 of the vehicle 100, the distance between the magnetic element 404 and the magnetic sensor 402 and/or the orientation of the magnetic sensor 402 relative to the magnetic element 404 can vary as the vehicle 100 travels or dives by the magnetic element 404.

Each magnetic sensor 402 of the one or more magnetic sensors 402 can output or generate a respective electric signal representing, corresponding to, or indicative of the magnetic field magnitude sensed by the magnetic sensor 402. The electric signal output by the magnetic sensor 402 can be indicative of the varying distance between the magnetic sensor 402 and the magnetic element 404 and/or the varying orientation of the magnetic sensor 402 relative to the magnetic element 404. Given that each of the one or more magnetic sensors 402 is fixed or mounted at a corresponding position at the vehicle 100, the electric signal(s) output by the one or more magnetic sensors 402 can be used to determine or estimate at least one of the velocity of the vehicle 100 or the yaw rate of the vehicle 100.

The one or more magnetic sensors 402 can include one or more coils each of which connected to, or arranged in, a respective electric circuit. As the vehicle 100 travels or drives by the magnetic element 404, the magnetic flux density in the coil varies and causes induced current in the coil. The magnetic flux density in the coil varies responsive to variation in the distance between the coil and the magnetic element 404 and/or the variation in the relative orientation of the coil with respect to the magnetic element 404. The electric circuit for each coil can record the electric signal representing the induced current in the coil, e.g., the voltage of the induced current over time.

In some implementations, the one or more magnetic sensors 402 can include one or more Hall elements that use the Hall effect to detect or sense the magnetic field generated by the magnetic element 404. A Hall element can be connected to an electric circuit and can generate a voltage at right angles to the direction of the exterior magnetic field and the electric current flowing through the Hall element. The voltage generated by the Hall element is referred to or known as a Hall voltage. The magnitude and direction, e.g., plus or minus, of the voltage make it possible to detect the magnitude and direction of the magnetic field generated by the magnetic element. In other words, the magnitude and direction of the voltage generated by the Hall element can be indicative of the distance between the Hall element and the magnetic element 404 and the orientation of the Hall element relative to the magnetic element 404. Voltage signal(s) generated by one or more Hall elements, as the vehicle 100 drives or travels by the magnetic element, can be used to determine or estimate at least one of the velocity of the vehicle 100 or the yaw rate of the vehicle 100.

In some implementations, the one or more magnetic sensors 402 can include or can be connected to one or more reed switches. A reed switch can include a glass tube encapsulating two reeds, or contacts, coupled to the right and left ends of the tube. The reeds can be made of nickel or other magnetic material and can be separated by a gap in the middle of the glass tube. The reed switch can be open in its default state. When the ends of the contacts are exposed to a magnetic field, the contacts are magnetized and are attracted to each other closing the circuit. The reed switch(es) can trigger the recording of electric signal(s) responsive to the vehicle 100 travels or drives by the magnetic element.

In some implementations, the one or more magnetic sensors 402 can include other types of magnetic sensors, such as one or more superconducting quantum interference devices (SQUIDs), one or more Hall effect integrated circuits (ICs), one or more magneto-resistance (MR) sensor elements, one or more anisotropic magneto-resistance (AMR) sensor elements, one or more giant magneto-resistance (GMR) sensor elements, one or more tunnel magneto-resistance (TMR) sensor elements or a combination thereof. The MR sensor element(s), AMR sensor element(s), GMR sensor element(s) and/or TMR sensor elements can be used as rotation angle sensors to detect yaw rate of the vehicle 100.

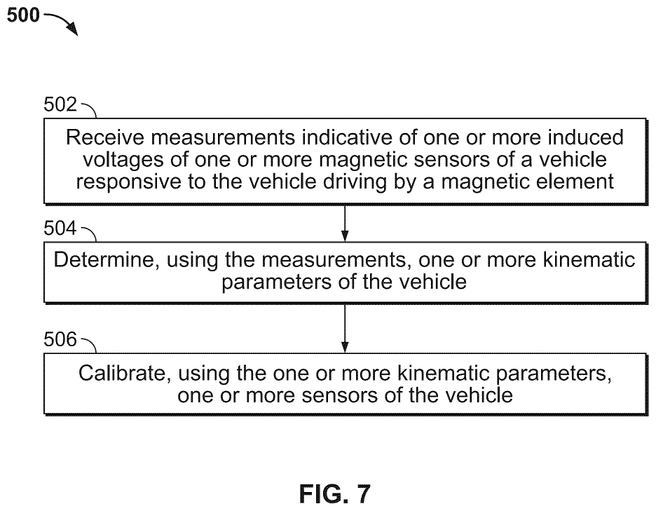

FIG. 7 is a flowchart of a method 500 for online calibration of vehicle sensors, according to an example embodiment of the current disclosure. In brief over view, the method can include receiving, at 502, from one or more magnetic sensors 402 mounted to vehicle 100, measurements indicative of, or associated with, a magnetic field generated by magnetic element 404, responsive to the vehicle 100 driving by the magnetic element 404. The method 500 can include determining, at 504, one or more kinematic parameters of the vehicle 100 using the measurements received from the one or more magnetic sensors 402, and calibrating, at 506, one or more sensors of the vehicle 100 using the one or more kinematic parameters of the vehicle 100. The method 500 can be executed by the autonomy computing system 200, the calibration module 230 and/or the processor 302.

The method 500 can include, at 502, the autonomy computing system 200 or the calibration module 230 receiving, from the magnetic sensor(s) 402, measurements indicative of the magnetic field generated by the magnetic element 404, responsive to the vehicle 100 driving or traveling by the magnetic element 404. Magnetic elements 404, e.g., magnetic strips, can be placed on the surfaces of various roads 10. As the vehicle 100 drives or travels by a magnetic element 404 on a road surface, the magnetic field generated by the magnetic element 404 can induce electric voltages in the magnetic sensor(s) 402 of the vehicle 100. For example, if a magnetic sensor 402 is a coil, the magnetic field can induce electric current in the coil. The coil can be connected to a resistor and the voltage across the resistor, which is linearly proportional to the induced current in the coil, can be indicative of the variation in the magnetic flux intensity through the coil. Specifically, the voltage across the resistor is also linearly proportional to the derivative of the magnetic flux through the coil. For Hall element, the Hall voltage is also linearly proportional to the magnetic flux crossing the Hall element.

The autonomy computing system 200 or the calibration module 230 can receive one or more voltage signals, e.g., induced voltage signal(s) or Hall voltage signal(s), from the one or more magnetic sensors 402, responsive to the vehicle 100 driving or traveling by the magnetic element 404. Each voltage signal can be indicative of the magnetic flux or variation thereof associated with the corresponding magnetic sensor 402. The voltage signal(s) can be indicative of kinematic parameters and/or other related parameters of the vehicle 100.

In general, the autonomy computing system 200 or the calibration module 230 can receive measurements indicative of one or more electric signals, electric parameters and/or electromagnetic parameters measured by the one or more magnetic sensors 402 of the vehicle 100. In particular, the magnetic sensor(s) 402 can measure or record voltage signals, electric current signal, electric resistance measurements and/or magnetic flux measurements among others. For example, a coil-based magnetic sensor can provide measurements of induced current or induced voltage over time. A Hall element can provide measurements of Hall voltage over time. MR sensor elements, AMR sensor elements, GMR sensor elements and TMR sensor elements can provide electric resistance measurements.

The method 500 can include, at 504, the autonomy computing system 200 or the calibration module 230 determining one or more kinematic parameters of the vehicle 100 using the measurements from the one or more magnetic sensors 402. For example, the autonomy computing system 200 or the calibration module 230 can determine the velocity and/or the yaw rate of the vehicle 100 using the measurements from the magnetic sensor(s) 402. In some implementations, the autonomy computing system 200 or the calibration module 230 can determine a dynamic rolling radius of the vehicle 100 using the measurements from the magnetic sensor(s) 402.

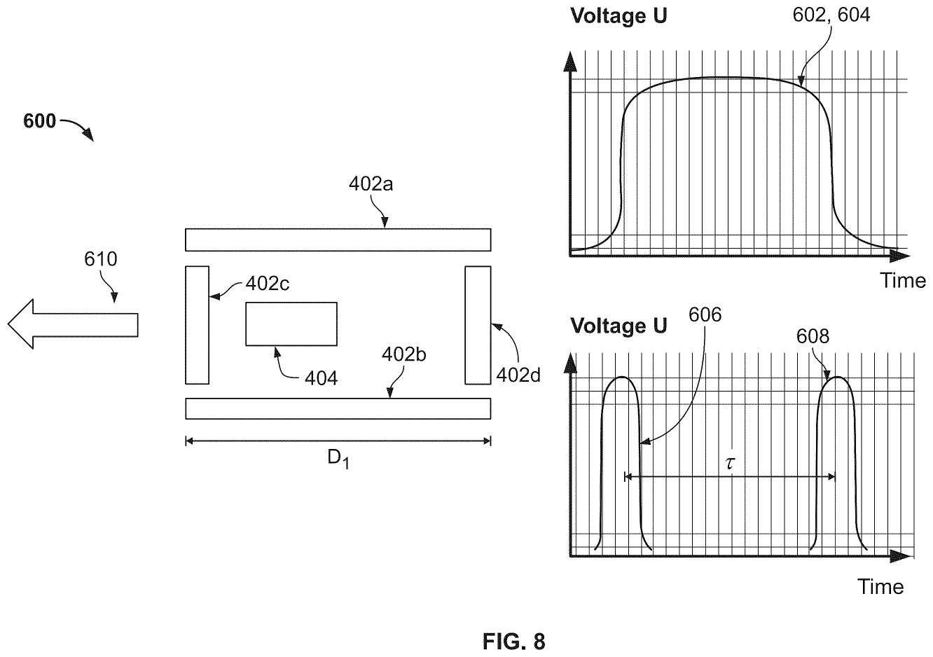

Referring now to FIG. 8, a diagram of an example configuration 600 of magnetic sensors mounted to a vehicle 100 and corresponding voltage measurements 602, 604, 606 and 608 are shown, according to an example embodiment of the current disclosure. The vehicle 100 can include magnetic sensors 402a, 402b, 402c and 402d. The magnetic sensors 402a and 402b can be aligned along a length dimension of the vehicle 100. For example, the magnetic sensors 402a and 402b can be arranged, at the underside of the vehicle 100, parallel to each other along the length dimension of the vehicle 100. The magnetic sensors 402c and 402d can be aligned along a width dimension of the vehicle 100. For example, the magnetic sensors 402c and 402d can be arranged, at the underside of the vehicle 100, parallel to each other along the width dimension of the vehicle 100. The magnetic sensors 402c and 402d can be spaced apart by a distance D₁ along the length dimension of the vehicle 100. In some implementations, the magnetic sensors 402a and 402b can have a length equal to D₁.

The plots 602 and 604 represent the Hall voltages (or voltage signals) recorded by magnetic sensors 402a and 402b, respectively, as the vehicle 100 drives or travels by the magnetic element 404 on the road 10. In FIG. 8, the plots or corresponding Hall voltage signals 602 and 604 are shown as a single signal or plot because both signals are equal to each other and overlap on one another. The Hall voltage signals 602 and 604 can be equal to each other if the magnetic sensors 402a and 402b are equally spaced from the magnetic element 404 as the vehicle 100 drives or travels by the magnetic element 404. As the vehicle 100 drives or travels along the direction 610, the Hall voltage signals 602 and 604 rise during the time period when the position of the magnetic sensors 402a and/or 402b along the driving direction 610 overlaps with the position of the magnetic element 404 along the direction 610.

The plots 606 and 608 represent the Hall voltages (or voltage signals) recorded by magnetic sensors 402c and 402d, respectively, as the vehicle 100 drives or travels past the magnetic element 404 on the road 10. The hall voltages 606 and 608 can be separated apart by a time shift (or time delay) t. As the vehicle 100 drives along the direction 610, the magnetic sensor 402c passes over the magnetic element 404 and records the Hall voltage signal 606. Then, the magnetic sensor 402d passes over the magnetic element 404 and records the Hall voltage signal 608. The time delay t depends on, or is defined by, the distance Di between the magnetic sensors 402c and 402d and the velocity or speed of the vehicle 100 as the vehicle 100 drives or travels by the magnetic element 404.

The autonomy computing system 200 or the calibration module 230 can receive the Hall voltages 602, 604, 606 and 608 from the magnetic sensors 402a, 402b, 402c and 402d, respectively, in real-time. The autonomy computing system 200 or the calibration module 230 can determine the time shift (or time delay) t between the voltage signals 606 and 608. The autonomy computing system 200 or the calibration module 230 can determine the speed or velocity v of the vehicle 100 by dividing the distance Di between the magnetic sensors 402c and 402d along the length dimension of the vehicle 100 by the time shift t between the voltage signals 606 and 608. In other words, the autonomy computing system 200 or the calibration module 230 can determine the speed or velocity v of the vehicle 100 as

$$ϑ = \frac{{D}_{1}}{τ} .$$

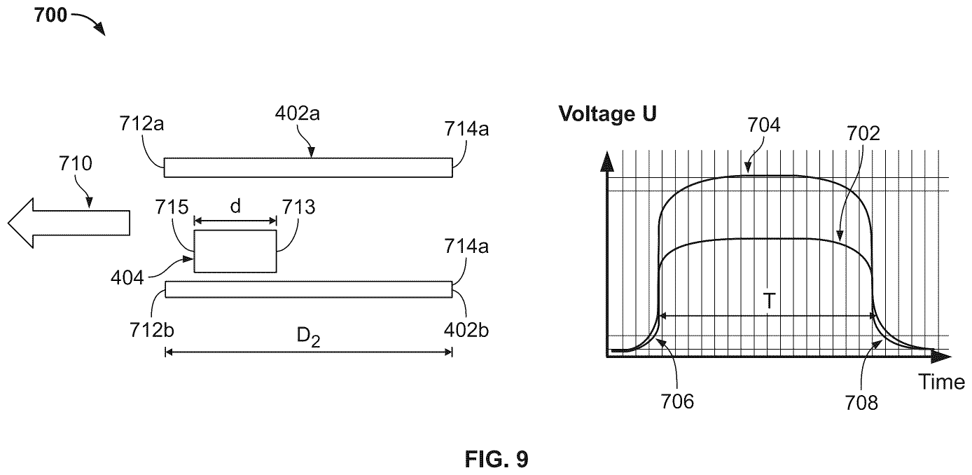

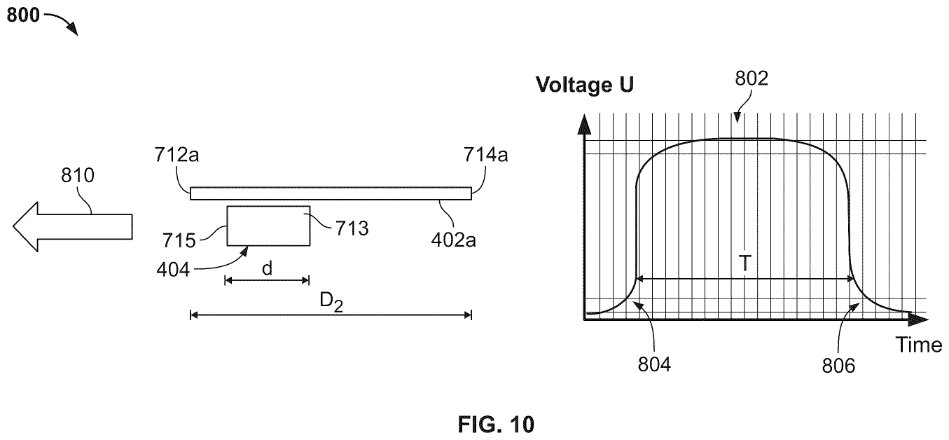

As described below in relation with FIGS. 9 and 10, the autonomy computing system 200 or the calibration module 230 can determine the speed or velocity v of the vehicle 100 using the voltage signal(s) (or voltage measurements) from the magnetic sensors 402a and/or 402b.

Referring now to FIG. 9, a diagram of another example configuration 700 of magnetic sensors mounted to a vehicle 100 and corresponding voltage measurements 702 and 704 are shown, according to an example embodiment of the current disclosure. The vehicle 100 can include magnetic sensors 402a and 402b. The magnetic sensors 402a and 402b can be aligned along the length dimension of the vehicle 100. For example, the magnetic sensors 402a and 402b can be arranged, at the underside of the vehicle 100, parallel to each other along the length dimension of the vehicle 100. In some implementations, the magnetic sensors 402a and 402b can have a length equal to D₂. In some implementations, the magnetic sensors 402a and 402b can have different lengths. In FIG. 9, the magnetic sensor 402b may be closer to the magnetic element 404 than the magnetic sensor 402b as the vehicle 100 drives or travels by the magnetic element 404.

The plots 702 and 704 represent the Hall voltages (or voltage signals) recorded by magnetic sensors 402a and 402b, respectively, as the vehicle 100 drives or travels by the magnetic element 404 on the road 10. The Hall voltage signals 602 and 604 can have different magnitudes depending on the distances between the magnetic element 404 and each of the magnetic sensors 402a and 402b. In particular, the voltage signal 704 can have a higher magnitude than the voltage signal 702 since the magnetic sensor 402b is closer to the magnetic element 404 than the magnetic sensor 402a as the vehicle 100 drives or travels by the magnetic element 404. Assuming that the magnetic sensors 402a and 402b are parallel to each other and have the same length D₂, the voltage signals 702 and 704 can have overlapping rising edges 706 and overlapping decreasing or falling edges 708. The voltage signals 702 and 704 can have a time duration T, e.g., defined between the rising edge(s) 706 and the falling edge(s) 708.

The autonomy computing system 200 or the calibration module 230 can determine the time duration T of the voltage signal(s) 702 and/or 704. For example, the autonomy computing system 200 or the calibration module 230 can determine the time duration T as the time shift or time delay between the rising edge(s) 706 and the falling or decreasing edge(s) 708 along a defined voltage value. The autonomy computing system 200 or the calibration module 230 can determine the time duration T as the time shift or time delay between the maximum derivative at the rising edge(s) 706 and the maximum derivative at the falling or decreasing edge(s) 708. The autonomy computing system 200 or the calibration module 230 can determine the speed or velocity v of the vehicle 100 by dividing a distance defined by at least one of a dimension of the magnetic sensor(s) 402a and/or 402b or a dimension of the magnetic element 404.

As the vehicle 100 drives or travels along the direction 710, the rising edge(s) 706 of voltage signals 702 and 704 can occur when the leading ends or edges 712a and 712b of the magnetic sensors 402a and 402b coincide or are aligned with the leading end or edge 713 of the magnetic element 404. The falling or decreasing edge(s) 708 can occur when the ends or edges 714a and 714b coincide or are aligned with the end or edge 715 of the magnetic element 404. The autonomy computing system 200 or the calibration module 230 can determine the speed or velocity v of the vehicle 100 as

$$ϑ = \frac{d + {D}_{2}}{T} .$$

Referring now to FIG. 10, a diagram of yet another example configuration 800 of magnetic sensors mounted to a vehicle 100 and corresponding voltage measurements 802 are shown, according to an example embodiment of the current disclosure. The vehicle 100 can be drive along direction 810. The vehicle 100 can include magnetic sensor 402a, e.g., arranged or mounted along the underside of the vehicle 100 and aligned along the length dimension of the vehicle 100. The magnetic sensor 402a can have a length equal to D₂, e.g., similar to FIG. 9. The plot 802 represents the Hall voltage (or voltage signal) recorded by magnetic sensors 402a as the vehicle 100 drives or travels by the magnetic element 404. The voltage signal 802 can have a rising edge 804 and a falling or decreasing edge 806. The voltage signal 802 can have a time duration T, e.g., defined between the rising edge(s) 804 and the falling edge(s) 806 as described above in relation to FIG. 9.

The autonomy computing system 200 or the calibration module 230 can determine the time duration T of the voltage signal 802 and use the time duration T to determine the speed or velocity v of the vehicle 100. For example, the autonomy computing system 200 or the

$$ϑ = \frac{d + {D}_{2}}{T} .$$

In some implementations, the autonomy computing system 200 or the calibration module 230 can determine the speed or velocity v of the vehicle 100 as

$$ϑ = \frac{f ( d , {D}_{2} )}{T} ,$$

where ƒ(d, D₂) is a function of d and D₂.

The autonomy computing system 200 or the calibration module 230 can determine a dynamic rolling radius (or wheel radius) r_{dyn} of the vehicle 100 using the determined speed or velocity v of the vehicle 100. For example, the autonomy computing system 200 or the calibration module 230 can determine an angular velocity @wheel of the engine or wheel(s) of the vehicle 100 using measurements from an engine speed sensor of the vehicle 100. The engine speed sensor can provide a measurement of the engine speed n_{wheel} representing the number of engine or wheel rotations per time unit (e.g., per second) while the vehicle 100 is driving or traveling by the magnetic member 404. The autonomy computing system 200 or the calibration module 230 can determine the dynamic rolling radius (or wheel radius) r_{dyn} of the vehicle 100 as

$${r}_{dyn} = \frac{ϑ}{{ω}_{wheel}} = \frac{ϑ}{2 \cdot π \cdot {n}_{wheel}} .$$

The wheel radius of vehicle 100 can gradually decrease over time primarily due to tire wear. In particular, as the tread depth diminishes, the dynamic rolling radius r_{dyn} of the vehicle 100 also decreases causing a slight decrease in the overall wheel size. The change in the dynamic rolling radius r_{dyn} affects measurements of the linear speed or velocity of the vehicle 100 displayed on the speedometer. Specifically, the linear speed or velocity is determined using the measured engine speed n_{wheel} as v=2·π·r·n_{wheel}, where r is usually a static radius of the wheel(s). An error in r translates into an error in the linear speed of the vehicle 100 equal to v−θ=2·π·(r−r_{dyn})·n_{wheel}.

In some implementations, the autonomy computing system 200 or the calibration module 230 can determine the yaw rate of the vehicle 100 using measurements from the magnetic sensor(s) 402. If the vehicle 100 turns while driving or traveling past the magnetic element 404, the shape(s) of the measurement profiles or voltage signals recorded by the magnetic sensor(s) 402 can change compared to the voltage signals 602, 604, 606, 608, 702, 704 and 802 shown in FIGS. 8-10. For example, if the vehicle 100 turns left while passing by magnetic element 404, the magnetic sensor 402a will be closer to magnetic element 404 than sensor 402b leading to an increase in the magnitude of the voltage signal 702 associated with sensor 402a, and the magnetic sensor 402b will move away from the magnetic element 404 leading to a decrease in the magnitude of the associated sensor voltage signal 704.

The autonomy computing system 200 or the calibration module 230 can compare a first profile of measurements, e.g., voltage signal 602 or 702, received from the magnetic sensor 402a and a second profile of measurements, e.g., voltage signal 604 or 704, received from the magnetic sensor 402b to determine the yaw rate of the vehicle 100. For example, the autonomy computing system 200 or the calibration module 230 can determine based on the shape(s) of the voltage signal(s) 602 and 604 (or 702 and 704) whether the vehicle 100 is turning left or right. The autonomy computing system 200 or the calibration module 230 can compute slopes of the voltage signal(s) 602 and 604 (or 702 and 704) and determine based on the computed slopes whether the vehicle 100 is turning or deviating left or right. The autonomy computing system 200 or the calibration module 230 can determine the yaw rate of the vehicle 100 based on the comparison between the profiles of measurement. For example, the autonomy computing system 200 or the calibration module 230 can determine the yaw rate of the vehicle 100 using the slopes of the voltage signals 602 and 604 (or 702 and 704). The autonomy computing system 200 or the calibration module 230 can use a lookup table to map the computed slopes to yaw rate values. In some implementations, the autonomy computing system 200 or the calibration module 230 can use other features of the voltage signals 602 and 604 (or 702 and 704) to determine the yaw rate of the vehicle 100.

In general, the autonomy computing system 200 or the calibration module 230 can use measurements from one or more magnetic sensors 402 of the vehicle 100 to determine the yaw rate. For example, the autonomy computing system 200 or the calibration module 230 can compare a profile of measurements, e.g., voltage signal 802, received from magnetic sensor 402a to one or more reference profiles, e.g., reference voltage signals associated with different yaw rate values. The reference profiles (or reference voltage signals) can be generated offline and stored in a memory accessible to the autonomy computing system 200 or the calibration module 230. The autonomy computing system 200 or the calibration module 230 can determine the yaw rate of the vehicle 100 based on the comparison. For example, the autonomy computing system 200 or the calibration module 230 can determine the yaw rate of the vehicle 100 to be equal to the yaw rate associated with the best matching reference profile. In some implementations, the autonomy computing system 200 or the calibration module 230 can determine the yaw rate of the vehicle 100 based on one or more features, e.g., slope values, of the profile of measurements (e.g., voltage signal 802) received from a magnetic sensor 402 of the vehicle 100 (e.g., with no reference profiles).

In some implementations, the autonomy computing system 200 or the calibration module 230 can use a trained machine learning model to determine the kinematic parameter(s) of the vehicle 100, such as the velocity and/or the yaw rate. The trained machine learning model can include a neural network, a decision tree, a random forest, a linear regression model and/or a logistic regression model. The machine learning model can be trained with training data to receive measurements from the magnetic sensor(s) 402 and output the kinematic parameter(s) of the vehicle 100.

During the deployment phase, the autonomy computing system 200 or the calibration module 230 can provide the measurement received from the magnetic sensor(s) 402 as input to the trained machine learning model, and cause the trained machine learning model to be executed and obtain output from the trained machine learning model indicative of the kinematic parameter(s) of the vehicle 100. For example, the autonomy computing system 200 or the calibration module 230 can provide one or more voltage signals, e.g., 602, 604, 606 and/or 608, 702 and/or 704, or 802, received from one or more magnetic sensors 402 as input to the trained machine learning model, and obtain one or more kinematic parameter values of the vehicle 100 from the trained machine learning model.

In some implementations, the autonomy computing system 200 or the calibration module 230 can determine the yaw rate of the vehicle 100 using measurement(s) from one or more MR sensor elements, one or more AMR sensor elements, one or more GMR) sensor elements, one or more TMR sensor elements or a combination thereof. For example, the vehicle 100 can include one or more MR sensor elements, one or more AMR sensor elements, one or more GMR) sensor elements and/or one or more TMR sensor elements to measure the yaw rate in addition to one or more Hall effect sensors to measure the linear velocity of the vehicle 100.

Referring back to FIG. 7, the method 500 can include the autonomy computing system 200 or the calibration module 230 calibrating, using the one or more kinematic parameters of the vehicle 100, one or more sensors 202 of the vehicle 100. The autonomy computing system 200 or the calibration module 230 can calibrate IMU 224 of the vehicle 100 using the one or more kinematic parameters determined at 504. For example, the autonomy computing system 200 or the calibration module 230 can calibrate vehicle velocity values and/or yaw rate values provided by IMU 224 using velocity values and/or yaw rate values determined based on measurements from the magnetic sensor(s) 402. The autonomy computing system 200 or the calibration module 230 can calibrate radar sensor(s) 210 and/or LiDAR sensor(s) 212 using the one or more kinematic parameters determined at 504. For example, the autonomy computing system 200 or the calibration module 230 can calibrate vehicle velocity values and/or yaw rate values provided by radar sensor(s) 210 and/or LiDAR sensor(s) 212 using velocity values and/or yaw rate values determined based on measurements from the magnetic sensor(s) 402. The autonomy computing system 200 or the calibration module 230 can calibrate velocity values and/or yaw rate values of the vehicle 100 measured or provided by GNSS receiver 222 using velocity values and/or yaw rate values determined based on measurements from the magnetic sensor(s) 402.

The radar sensors 210, LiDAR sensors 212, IMUs 224 and/or other types of sensors used to measure kinematic parameters of the vehicle 100 can become out of calibration over time due to various factors. Also, measurements provided by the GNSS receiver 222 can be associated with some error. The measurements provided by the magnetic sensors 402 enable calibration of sensors used to measure kinematic parameters.

For the IMU 224, the autonomy computing system 200 or the calibration module 230 can determine a velocity offset between a vehicle velocity measured by the IMU 224 and the vehicle velocity θ determined using the magnetic sensor(s) 402 and/or a yaw rate offset between the yaw rate measured by the IMU 224 and the yaw rate measured using the magnetic sensor(s) 402. The autonomy computing system 200 or the calibration module 230 can use the velocity offset and/or the yaw rate offset to adjust one or more internal parameters of the IMU 224 to effectively tune the IMU 224 to provide more accurate readings.

A similar calibration process can be applied to radar sensors 210 and/or LiDAR sensors 212. For example, the autonomy computing system 200 or the calibration module 230 can determine a velocity offset value between a vehicle velocity measured by a radar sensor 210 and the vehicle velocity/determined using the magnetic sensor(s) 402, and use the velocity offset value to adjust one or more internal parameters of the radar sensor 210 to tune the radar sensor 210 to provide more accurate readings. The autonomy computing system 200 or the calibration module 230 can determine another velocity offset value between a vehicle velocity measured by a LiDAR sensor 212 and the vehicle velocity/determined using the magnetic sensor(s) 402, and use the velocity offset value to adjust one or more internal parameters of the LiDAR sensor 212 to tune the LiDAR sensor 212 to provide more accurate readings.

The autonomy computing system 200 or the calibration module 230 can provide the dynamic rolling radius (or wheel radius) r_{dyn} to a vehicle speed sensor or a controller thereof. The vehicle speed sensor or the respective controller can use the dynamic rolling radius (or wheel radius) r_{dyn} to determine vehicle linear speed based on engine angular velocity.

In some implementations, the method 500 can be triggered responsive to detecting a magnetic field greater than a defined threshold. For example, one or more reed switches can be used as a trigger.

In some implementations, the methods described herein can be implemented by a system integrated onboard the vehicle. In some implementations, the methods described herein can be implemented by a system remote from the vehicle. For example, the system can be implemented in the cloud and can receive sensor measurements from vehicle sensors via a telecommunication network.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for online sensor calibration in vehicles, the system comprising:
one or more magnetic sensors mounted to a vehicle; and
a processing device in communication with the one or more magnetic sensors, the processing device is configured to execute instructions stored in a memory to perform operations comprising:
receive, from the one or more magnetic sensors, measurements indicative of one or more induced voltages of the one or more magnetic sensors responsive to the vehicle driving by a magnetic element;
determine, using the measurements received from the one or more magnetic sensors, one or more kinematic parameters of the vehicle; and
calibrate, using the one or more kinematic parameters of the vehicle, one or more sensors of the vehicle.

2. The system of claim 1, wherein the magnetic element includes a magnetic strip placed on a road surface.

3. The system of claim 1, wherein the one or more kinematic parameters of the vehicle include at least one of:
a velocity of the vehicle; or
a yaw rate of the vehicle.

4. The system of claim 1, wherein the processing device is configured to:
determine, using the measurements received from the one or more magnetic sensors, a dynamic rolling radius of the vehicle.

5. The system of claim 1, wherein the one or more magnetic sensors are mounted at an underside of the vehicle.

6. The system of claim 1, wherein the one or more magnetic sensors include at least one of:
one or more magnetic sensor aligned along a length dimension of the vehicle; or
a pair of magnetic sensors aligned along a width dimension of the vehicle and spaced apart by a distance along the length dimension of the vehicle.

7. The system of claim 1, wherein the processing device is configured to:
determine a time shift between first measurements from a first magnetic sensor aligned along a width dimension of the vehicle and second measurements from a second magnetic sensor aligned along the width dimension of the vehicle, the first and second magnetic sensors spaced apart by a distance along a length dimension of the vehicle; and
determine a speed of the vehicle by dividing the distance between the first and second magnetic sensors spaced along the length dimension of the vehicle by the time shift between the first and second measurements.

8. The system of claim 1, wherein the processing device is configured to:
determine a duration of measurements received from one or more magnetic sensors aligned along a length dimension of the vehicle; and
determine a speed of the vehicle by dividing a distance defined by at least one of (i) a dimension of the one or more magnetic sensors aligned along the length dimension of the vehicle and (ii) a dimension of the magnetic element.

9. The system of claim 1, wherein the processing device is configured to:
compare a first profile of measurements received from a first magnetic sensor and a second profile of measurements received from a second magnetic sensor, the first and second sensors aligned along a length dimension of the vehicle; and
determine a yaw rate of the vehicle based on the comparison between the first profile and the second profile.

10. The system of claim 1, wherein the processing device is configured to:
compare a profile of measurements received from a magnetic sensor aligned along a length dimension of the vehicle and a reference profile; and
determine a yaw rate of the vehicle based on the comparison between the reference profile and the profile of the measurements received from the magnetic sensor aligned along the length dimension of the vehicle.

11. The system of claim 1, wherein to determine the one or more kinematic parameters of the vehicle, the processing device is configured to:
provide the measurement received from the one or more magnetic sensors as input to trained machine learning model; and
execute the trained machine learning model to obtain output from the trained machine learning model indicative of the one or more kinematic parameters of the vehicle.

12. The system of claim 1, wherein the processing device is configured to calibrate, using the one or more kinematic parameters of the vehicle, at least one of:
an inertial measurement unit (IMU) of the vehicle;
a velocity measured by radar sensor of the vehicle; or
a velocity measured by global positioning system (GPS) device of the vehicle.

13. A method for online sensor calibration in vehicles, the method comprising:
receiving, by a processing device, from one or more magnetic sensors mounted to a vehicle, measurements indicative of one or more induced voltages of the one or more magnetic sensors responsive to the vehicle driving by a magnetic element;
determining, by the processing device, using the measurements received from the one or more magnetic sensors, one or more kinematic parameters of the vehicle; and
calibrating, using the one or more kinematic parameters of the vehicle, one or more sensors of the vehicle.

14. The method of claim 13, wherein the magnetic element includes a magnetic strip placed on a road surface and the one or more kinematic parameters of the vehicle include at least one of:
a velocity of the vehicle;
a yaw rate of the vehicle; or
a dynamic rolling radius of the vehicle.

15. The method of claim 13, comprising:
determining a time shift between first measurements from a first magnetic sensor aligned along a width dimension of the vehicle and second measurements from a second magnetic sensor aligned along the width dimension of the vehicle, the first and second magnetic sensors spaced apart by a distance along a length dimension of the vehicle; and
determining a speed of the vehicle by dividing the distance between the first and second magnetic sensors spaced along the length dimension of the vehicle by the time shift between the first and second measurements.

16. The method of claim 13, comprising:
determining a duration of measurements received from one or more magnetic sensors aligned along a length dimension of the vehicle; and
determining a speed of the vehicle by dividing a distance defined by at least one of (i) a dimension of the one or more magnetic sensors aligned along the length dimension of the vehicle and (ii) a dimension of the magnetic element.

17. The method of claim 13, comprising:
comparing a first profile of measurements received from a first magnetic sensor and a second profile of measurements received from a second magnetic sensor, the first and second sensors aligned along a length dimension of the vehicle; and
determining a yaw rate of the vehicle based on the comparison between the first profile and the second profile.

18. The method of claim 13, comprising:
comparing a profile of measurements received from a magnetic sensor aligned along a length dimension of the vehicle and a reference profile; and
determining a yaw rate of the vehicle based on the comparison between the reference profile and the profile of the measurements received from the magnetic sensor aligned along the length dimension of the vehicle.

19. The method of claim 13, wherein determining the one or more kinematic parameters of the vehicle incudes:
providing the measurement received from the one or more magnetic sensors as input to trained machine learning model; and
executing the trained machine learning model to obtain output from the trained machine learning model indicative of the one or more kinematic parameters of the vehicle.

20. The method of claim 13, comprising:
calibrating, using the one or more kinematic parameters of the vehicle, at least one of:
an inertial measurement unit (IMU) of the vehicle;
a velocity measured by radar sensor of the vehicle; or
a velocity measured by global positioning system (GPS) device of the vehicle.
